(19) United States
(12) Patent Application Publication
(10) Pub. No.: US 2024/0044161 A1
(43) Pub. Date: Feb. 8, 2024

(54) SWIMMING POOLS AND SPAS WITH WATER USAGE CONTROL

(71) Applicant: ZODIAC POOL SYSTEMS LLC, Carlsbad, CA (US)

(72) Inventors: Darin Eames, Carlsbad, CA (US); Dindo Uy, North Hollywood, CA (US); Mark J. Bauckman, San Marcos, CA (US); Robert Warren Stiles Jr., San Marcos, CA (US)

(73) Assignee: ZODIAC POOL SYSTEMS LLC, Carlsbad, CA (US)

(21) Appl. No.: 18/231,504

(22) Filed: Aug. 8, 2023

Related U.S. Application Data
(60) Provisional application No. 63/396,054, filed on Aug. 8, 2022.

(51) Int. Cl. E04H 4/12

(52) U.S. Cl. CPC E04H 4/12

(57) ABSTRACT

A control system for a swimming pool or spa may detect a water level of the swimming pool or spa. The water level may be detected based on information from an APC, information from an environmental sensor, and/or information from an optical sensor. In various embodiments, the control system may determine or estimate a cause of water displacement based on the received information from the APC, environmental sensors, and/or optical sensors.

### REFERENCE TO RELATED APPLICATION

The application claims the benefit of U.S. Provisional Patent Application No. 63/396,054, filed on Aug. 8, 2022, and entitled SWIMMING POOLS AND SPAS WITH WATER USAGE CONTROL, the content of which is hereby incorporated by reference in its entirety.

### FIELD OF THE INVENTION

The invention relates to systems and methods for water-containing vessels such as swimming pools and spas, and more particularly to systems and methods for water usage control in swimming pools and spas.

### BACKGROUND OF THE INVENTION

Water displacement from a swimming pool or spa has traditionally been determined based on a visual observation of the water level within the swimming pool or spa. However, the cause of water displacement is often unknown to pool owners because they may not be physically observing the pool all the time, and certain components of the swimming pool or spa are not easily observable. As such, other than re-filling the pool or spa to a desired level, most pool owners take no further actions upon an observation of a decreased water level. Other pool statuses such as flow within the pool, temperature gradients within the pool, equipment statuses, etc. are likewise not easily observable and thus unavailable to the pool owner.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an automatic swimming pool cleaner (APC) for a swimming pool or spa may sense a water level.

According to various embodiments, a control system for a swimming pool or spa may control a piece of equipment for the swimming pool or spa based on sensed information from an APC.

According to some embodiments, a method of operating a swimming pool or spa includes controlling a piece of equipment for the swimming pool or spa based on sensed information from an APC.

According to various embodiments, a control system for a swimming pool or spa may detect water displacement from the swimming pool or spa.

According to certain embodiments, a control system for a swimming pool or spa may determine a water displacement characteristic of water displacement from the swimming pool or spa and may generate a notification based on the determined water displacement characteristic.

According to some embodiments, a method of operating a swimming pool or spa includes (i) determining a water displacement characteristic of water displacement from the swimming pool or spa and (ii) generating a notification based on the determined water displacement characteristic.

According to various embodiments, a control system for a swimming pool or spa may (i) generate and display a virtual representation of a swimming pool or spa and (ii) manipulate the virtual representation based on real-time status information about the swimming pool or spa.

According to certain embodiments, a control system for a swimming pool or spa may generate and display a virtual representation of a swimming pool or spa. The virtual representation may include graphical information about a status of the swimming pool or spa and/or equipment of the swimming pool or spa.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 illustrates a pool interface according to embodiments.

### DESCRIPTION OF THE INVENTION

Described herein are control systems and methods for swimming pools or spas. In some embodiments, the systems and methods described herein use an APC for sensing information about the pool, and equipment for the swimming pool or spa may be controlled based on the information from the APC. In certain embodiments, the APC may sense a water level of the pool, and the control systems may control equipment for the pool based on the sensed water level. In various embodiments, the systems and methods described herein may determine a water displacement characteristic of water displacement from the swimming pool or spa and generate a notification and/or a control response in equipment for the pool based on the determined water displacement characteristic. In some examples, the water displacement characteristic may be amount of water displacement and/or a reason for water displacement. In some embodiments, the system and methods described herein may use a camera or other suitable optical sensor to detect or sense a water level of the pool. In various embodiments, the systems and methods described herein may utilize environmental data to estimate a water level, usage, and/or loss.

According to certain embodiments, control systems described herein may generate and display a virtual representation of a swimming pool or spa with graphical information about a status of the swimming pool or spa and/or its equipment. In some embodiments, the control systems may manipulate the virtual representation based on real-time status information about the swimming pool or spa.

In certain embodiments, the systems and methods described herein may detect or estimate water loss as well as estimate or detect a source or cause of the water loss. Estimating or detecting the source or cause of the water loss may be based on the water level data, environmental data, other sources of data (e.g., historical data), combinations thereof, and/or other data as desired. The systems and methods described herein advantageously may provide a user with an informed notification about water level and optionally may facilitate an identification of a leak in the pool system.

Various other benefits and advantages may be realized with the devices and methods provided herein, and the aforementioned advantages should not be considered limiting.

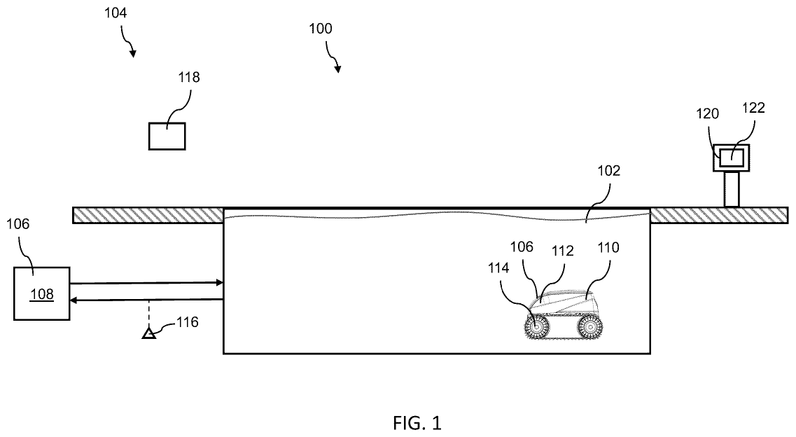

FIG. 1 illustrates an example of a pool system 100 including a swimming pool or spa (hereinafter “pool”) 102 and a control system 104.

One or more pieces of equipment 106 may be associated with the pool 102, such as but not limited to a pump 108, an APC 110, a skimming system, and other equipment as desired. The APC 110 generally includes a body 112, one or more motive elements 114, and one or more cleaning devices (including but not limited to a scrubber brush). A motor, pump, filter, and various other features may be provided on or within the APC 110 as desired. In some embodiments, the APC 110 optionally includes sensing means for sensing at least one characteristic of water of the pool 102 such as but not limited to a temperature, depth, flow, etc. The APC 10 may be various types of APCs as desired, and the particular APC 110 illustrated should not be considered limiting. Other non-limiting examples of APCs 110 may include those described in U.S. Pat. Nos. 9,488,154, 8,578,538, and U.S. Patent Publication No. 2014/0303810, all of which are hereby incorporated by reference in their entireties.

Optionally, the pool system 100 includes one or more sensors 116 for sensing and gathering information about the pool system 100. Such sensors 116 may include, but are not limited to, optical sensors, temperature sensors, pH sensors, flow sensors, turbidity sensors, combinations thereof, and/or other pool status sensors as desired. In certain embodiments, the one or more sensors 116 may detect at least one characteristic of water of the pool 102, such as but not limited to temperature, depth, flow, etc. As a non-limiting example, an optical sensor such as but not limited to a camera may have a field of view of at least a portion of the pool 102 and may detect a water level based on a detected surface of the water relative to an object or marking (e.g., on the wall of the pool or otherwise provided) having a known height or depth.

Optionally, the one or more sensors 116 may be one or more environmental sensors 124 that sense and/or gather environmental information about the environment and may provide environmental data such as but not limited to wind data, humidity data, air temperature data, cloud coverage data, direct sunlight exposure data, season or time of year, occupancy data (e.g., presence of a user in the pool 102), combinations thereof, and/or other environmental data as desired. Non-limiting examples of environmental sensors 124 include but are not limited to wind gauges, humidity sensors, temperature sensors, cameras (e.g., for optical sensing), combinations thereof, other water sensors, pool deck sensors, etc. Based on the additional information, the control system 104 may determine or estimate a water level, water displacement, or usage and/or a reason for the water displacement.

The control system 104 includes a controller 118 (processor and/or memory). The controller 118 may include a computer system and/or one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data. The memory device may be local to the controller, portable, on a server, or in the cloud, among other locations.

The controller 118 may be provided at various locations relative to the pool 102, including both on or withing a pool pad including the pool 102 and/or at a location remote from the pool 102. In certain embodiments, the controller 118 optionally includes an associated user interface 120, including but not limited to a graphical user interface or a human machine interface, such that the controller 118 may obtain information from a user and/or provide information to the user. Optionally, the interface 120 may include features such as but not limited to a speaker, screen 122, touchpad, lights, switches, combinations thereof, and/or other human machine interfaces as desired for receiving information from and/or providing information to a user. The user interface 120 and/or human machine interface may be on the controller 118 itself or may be at a location remote from the controller 118, such as on a user device, a dedicated user interface device, an operations control center remote from the pool system 100, combinations thereof, and/or as otherwise desired.

The controller 118 may be communicatively coupled with one or more pieces of equipment 106 using various wired or wireless communication techniques as desired.

In some embodiments, the controller 118 of the control system 104 receives sensed information from the APC 110 and/or the one or more sensors 116. In some embodiments, the controller 118 may detect a water level, water displacement, and/or water loss based on the sensed information, and/or the controller 118 may detect or estimate a cause of the water displacement or water loss. Optionally, the controller 118 generates a control response, such as but not limited to control of another piece of equipment 106 and/or generation of an alert or notification based on the sensed information from the APC 110 and/or the one or more sensors 116.

As a non-limiting example, the APC 110 may sense a water characteristic of water of the pool 102 such as the temperature of the water. In this example, based on the sensed temperature of the water from the APC 110, the controller 118 may determine a level of water of the pool. Optionally, based on the determined level of water, the controller 118 may control the pump 108 and/or other equipment 106 and/or otherwise generate a control response such as generating an alert, notification, and/or any other control response as desired. As a non-limiting example, the controller 118 may compare water temperatures at various known water depths, and based on this data, determine whether to run one or more pieces of pool equipment 106. As an example, if water temperature differs by depth too much, such a difference may indicate that the water is stagnant and needs to be circulated or heated more to be more comfortable and/or as otherwise desired.

As another non-limiting example, the controller 118 of the control system 104 may receive sensed information about a detected water level of the pool 102 from a camera as the one or more sensors 116. Based on the detected water level from the camera, the controller 118 may generate a control response such as controlling equipment 106, generating an alert or notification, and/or as otherwise desired.

As yet another non-limiting example, the controller 118 of the control system 104 may receive environmental data from one or more sensors 116, and based on the environmental data, the controller 118 may detect or estimate a water level, usage, and/or loss. As non-limiting examples, the controller 118 may estimate how much water will be used or lost (and/or a change in water level) based on wind, humidity, air temperature, cloud coverage, season, and/or as otherwise desired.

As another example of control of equipment 106 based on the water level, the controller 118 may control equipment 106 to offset water displacement determined based on the determined level of water of the pool. In another non-limiting example, the APC 110 may sense a pH of the water, and based on the sensed pH, the controller may control a chemical dosing system to adjust the pH of the water. Various other control of equipment 106 based on sensed information from the APC 110 may be implemented by the control system 104 as desired, and the aforementioned examples should not be considered limiting.

In certain embodiments, the control system 104 may determine a status of the water of the pool 102 and may determine or estimate one or more reasons for the status.

As a non-limiting example, the control system 104 may determine water displacement based on a change in water level using the aforementioned information from the APC 110. In this embodiment, the control system 104 may include additional information to determine a reason for the water displacement. Such additional information may include environmental information from the one or more environmental sensors 124 (e.g., wind gauges, humidity sensors, temperature sensors, cameras (e.g., for optical sensing), combinations thereof, etc.), other water sensors, pool deck sensors, historical usage information, etc. Based on the additional information, the control system 104 may determine or estimate one or more reasons for the water displacement. In examples with a plurality of additional information, the control system 104 may estimate or determine relative displacement due to various causes. As an example, if additional information includes air temperature information and occupancy information, the control system 104 may estimate a certain percentage or level of water displacement is due to evaporation and another percentage or level of water displacement is due to occupancy usage (e.g., splashing, etc.).

As one non-limiting example, the information from the APC 110 may provide the water level, and the additional information may include pool usage (e.g., a number of occupants) and an air temperature. In this example, the controller 118 may determine that water displacement may be due to a leak based on no occupants in the pool and a cool or not hot air temperature. Alternatively, the controller 118 may determine that water displacement may be due to occupant usage and evaporation based on a large number of occupants using the pool and the temperature being relatively hot.

Additionally, or alternatively, the control system 104 may determine water displacement based on a change in water level using information from the one or more sensors 116 such as but not limited to the optical sensors. In this example, the same sensor information (e.g., from the optical sensor) and/or additional sensor information (e.g., from one or more environmental sensors 124) may be utilized to determine or estimate a reason for water displacement. As a non-limiting example, a camera as the one or more sensors 116 may detect the water level, and additional information may include wind data and/or humidity data.

As another non-limiting example, the control system 104 may determine that a certain amount of water was likely displaced due to evaporation based on the environmental temperature, another amount of water was likely displaced due to splashing from occupants of the pool, and yet another amount was likely displaced due to leakage.

Optionally, the control system 104 may provide a notification or alert to a user and/or control equipment 106 based on the determined reason(s) for water displacement. Such notifications or alerts may include an actual or estimated water level, an actual or estimate water displacement, and/or one or more estimated reasons for water displacement.

In some embodiments, the notifications or alert may provide current water usage relative to historical water usage. As a non-limiting example, the control system 104 may provide an indication of average historical displacement for a given time period and may generate an alert or notification based on measured water displacement being greater than the average.

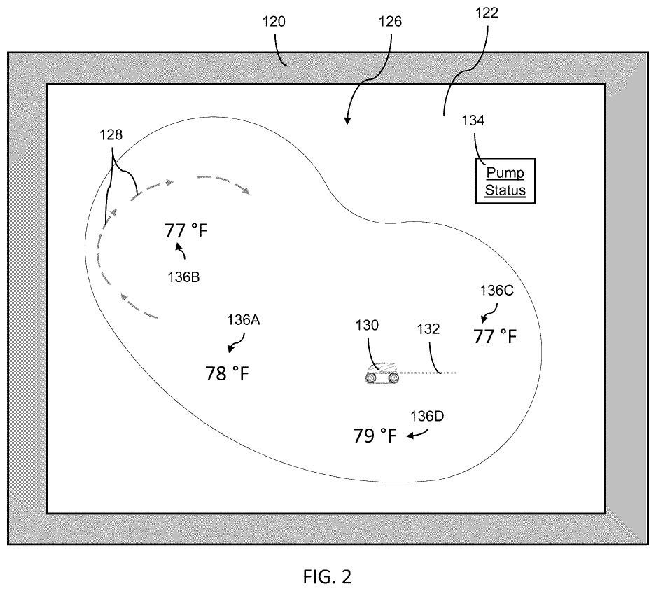

Referring to FIG. 2, in various embodiments, the control system 104 may provide information to a user of the pool 102 using the interface 120 and/or using a user's device (e.g., via an application). In certain embodiments, the control system 104 may generate and display a virtual representation of the pool 102 (referred to herein as a “virtual pool 126”) on the interface 120 and/or the user's device. The virtual pool 126 generated by the control system 104 includes various graphical information about one or more statuses of the pool 102. In the example of FIG. 2, the virtual pool 126 includes graphical information about a water flow pattern (arrows 128), water temperatures at various locations 136A-D, a location 130 of the APC 110 and a cleaning path 132 performed by the APC 110, and a status 134 of the pump 108. In various embodiments, the control system 104 manipulates the virtual pool 126 based on real-time status information about the pool 102. Other information and/or combinations of information about the pool 102 may be provided as desired. In certain embodiments, the virtual pool 126 may be customized by the user to display certain types of information about the pool.

The aforementioned examples of water usage control are for illustrative purposes only and should not be considered limiting, and in other embodiments, other types of water usage control may be utilized as desired.

Exemplary concepts or combinations of features of the invention may include:
A. An APC for a swimming pool or spa configured to sense water level.
B. A control system for a swimming pool or spa, the control system configured to determine a water level based on visual data from a camera.
C. The control system of any preceding or subsequent statement or combination of statements, wherein the control system comprises a controller.
D. The control system of any preceding or subsequent statement or combination of statements, wherein the control system is configured to generate a control response based on the determined water level.
E. The control system of any preceding or subsequent statement or combination of statements, wherein the controller is configured to control a piece of equipment for the swimming pool or spa as the control response and/or to generate an alert or notification to a user as the control response.
F. The control system of any preceding or subsequent statement or combination of statements, wherein the control system is further configured to determine a cause of water displacement in the swimming pool or spa based on the visual data.
G. The control system of any preceding or subsequent statement or combination of statements, wherein the control system is further configured to receive environmental data and determine a cause of water displacement in the swimming pool or spa based on the visual data and the environmental data.
H. A control system for a swimming pool or spa, the control system configured to estimate water displacement based on environmental data.
I. The control system of any preceding or subsequent statement or combination of statements, wherein the environmental data comprises at least one of wind data, humidity data, or air temperature data.
J. The control system of any preceding or subsequent statement or combination of statements, wherein the control system is further configured to determine a cause for the water loss based on the environmental data.
K. The control system of any preceding or subsequent statement or combination of statements, wherein the environmental data comprises at least two types of environmental data, and wherein the control system is configured to determine a plurality of causes for the water loss based on the at least two types of environmental data.
L. A control system for a swimming pool or spa, the control system configured to determine water displacement and a cause of water displacement based on data from an APC and/or one or more sensors.
M. A control system for a swimming pool or spa, the control system configured to control a piece of equipment for the swimming pool or spa based on sensed information from an APC.
N. The control system according to any preceding or subsequent statement or combination of statements, wherein the sensed information comprises water level information.
O. A method of operating a swimming pool or spa comprising controlling a piece of equipment for the swimming pool or spa based on sensed information from an APC.
P. A control system for a swimming pool or spa configured to detect water displacement from the swimming pool or spa.
Q. A control system for a swimming pool or spa, the control system configured to determine a water displacement characteristic of water displacement from the swimming pool or spa and to generate a notification based on the determined water displacement characteristic.
R. The control system according to any preceding or subsequent statement or combination of statements, wherein the water displacement characteristic comprises an amount of water displacement and/or a cause of water displacement.
S. The control system according to any preceding or subsequent statement or combination of statements, wherein the water displacement characteristic comprises a reason for water displacement.
T. The control system according to any preceding or subsequent statement or combination of statements, wherein the control system is further configured to control equipment for the swimming pool or spa based on the determined water displacement characteristic.
U. A method of operating a swimming pool or spa, the method comprising (i) determining a water displacement characteristic of water displacement from the swimming pool or spa and (ii) generating a notification based on the determined water displacement characteristic.
V. A control system for a swimming pool or spa, the control system configured to (i) generate and display a virtual representation of a swimming pool or spa and (ii) manipulate the virtual representation based on real-time status information about the swimming pool or spa.
W. A control system for a swimming pool or spa, the control system configured to generate and display a virtual representation of a swimming pool or spa, the virtual representation comprising graphical information about a status of the swimming pool or spa and/or equipment of the swimming pool or spa.
X. A control system for a swimming pool or spa, wherein the control system is configured to receive data from one or more sensors about a water displacement characteristic of water displacement from the swimming pool or spa, determine water displacement based on the received data, and determine at least one reason for the water displacement based on the received data.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy and for which cleaning of debris is needed or desired.

That which is claimed:

1. A control system for a swimming pool or spa, wherein the control system is configured to determine a water level of the swimming pool or spa based on visual data from at least one camera.

2. The control system of claim 1, wherein the control system is configured to generate a control response based on the determined water level.

3. The control system of claim 2, wherein the control system is configured to control a piece of equipment for the swimming pool or spa as the control response.

4. The control system of claim 2, wherein the control system is configured to generate an alert or notification to a user as the control response.

5. The control system of claim 1, wherein the control system is further configured to determine a cause of water displacement in the swimming pool or spa based on the visual data.

6. The control system of claim 1, wherein the control system is further configured to receive environmental data and determine a cause of water displacement in the swimming pool or spa based on the visual data and the environmental data.

7. A control system for a swimming pool or spa, wherein the control system is configured to receive environmental data from one or more environmental sensors and determine water loss from the swimming pool or spa based on the environmental data.

8. The control system of claim 7, wherein the environmental data comprises at least one of wind data, humidity data, or air temperature data.

9. The control system of claim 7, wherein the control system is further configured to receive visual data of at least a portion of the swimming pool or spa from at least one camera and to determine water loss based on the visual data.

10. The control system of claim 7, wherein the control system is further configured to determine a cause for the water loss based on the environmental data.

11. The control system of claim 7, wherein the environmental data comprises at least two types of environmental data, and wherein the control system is configured to determine a plurality of causes for the water loss based on the at least two types of environmental data.

12. The control system of claim 7, wherein the control system is further configured to generate a control response based on the determined water level, and wherein the control response comprises at least one of controlling equipment for the swimming pool or spa or generating an alert to a user.

13. A control system for a swimming pool or spa, wherein the control system is configured to receive data from one or more sensors about a water displacement characteristic of water displacement from the swimming pool or spa, determine water displacement based on the received data, and determine at least one reason for the water displacement based on the received data.

14. The control system of claim 13, wherein the control system is configured to control a piece of equipment for the swimming pool or spa based on determined water displacement.

15. The control system of claim 13, wherein the one or more sensors comprises an optical sensor.

16. The control system of claim 13, wherein the one or more sensors comprises an environmental sensor.

17. The control system of claim 13, wherein the control system is configured to determine a plurality of reasons for the water displacement based on the received data.

18. The control system of claim 13, wherein the control system is configured to generate a notification based on the determined water displacement characteristic.

19. The control system of claim 13, wherein the control system is configured to (i) generate and display a virtual representation of a swimming pool or spa and (ii) manipulate the virtual representation based on real-time status information about the swimming pool or spa.

20. The control system of claim 13, wherein the control system configured to generate and display a virtual representation of a swimming pool or spa, the virtual representation comprising graphical information about a status of the swimming pool or spa and/or equipment of the swimming pool or spa.
